(19) United States
(12) Patent Application Publication
(10) Pub. No.: US 2016/0229330 A1
(43) Pub. Date: Aug. 11, 2016

(54) TIE-DOWN DEVICE

(71) Applicant: Michael Pfahl, Wellington, FL (US)

(72) Inventor: Michael Pfahl, Wellington, FL (US)

(21) Appl. No.: 14/615,588

(22) Filed: Feb. 6, 2015

(51) Int. Cl. B60P 7/06; B60R 9/048; B25J 1/02

(52) U.S. Cl. CPC B60P 7/06; B25J 1/02; B60R 9/048

(57) ABSTRACT

A tie down device for securing cargo to a vehicle roof rack comprising: a telescoping rod; a first end of the telescoping rod; a second end of the telescoping rod; and a hook attached to a distal end of the rod. In one particular embodiment, the first end may include a handle and the hook attaches to the opposing telescoping end. The telescoping rod may expand to various lengths and in one particular embodiment may expand up to 76 inches in length.

### BACKGROUND OF THE INVENTION

1. Field of Invention

The present invention relates to a device that is used to assist in the securing of items in a roof rack of a vehicle.

2. Description of Related Art

Many individuals use roof racks that are placed on vehicles such as automobiles or sport utility vehicles to secure luggage or other items such as a canoe or a kayak. These roof racks provide additional storage space outside of the vehicle so that the user may transport additional items in a convenient manner. The typical roof rack requires an individual to tightly secure the luggage or cargo through the use of straps, ropes or pulleys. These items are used to mount the cargo in a secure manner on the roof of the vehicle. Typically a user has to either climb onto the vehicle in an awkward position to secure the straps or use a ladder in order to reach certain areas of the roof rack. Use of the ladder and standing on the vehicle can be hazardous to the user and increase the likelihood of an injury or slip and fall. Although various types of straps and bungee cords are used to secure luggage many times there is lack of any assistance in negotiating the height to position the straps over the cargo and securely place the cargo in a secured position on the roof rack. As a consequence, it would be advantageous to have a device that could be suitable to assist in securing cargo on a roof rack of a vehicle.

### SUMMARY OF THE INVENTION

The present invention relates to a tie down device for securing cargo to a vehicle roof rack comprising: a telescoping rod; a first end of the telescoping rod; a second end of the telescoping rod; and a hook attached to a distal end of the rod. In one particular embodiment, the first end may include a handle and the hook attaches to the opposing telescoping end. The telescoping rod may expand to various lengths and in one particular embodiment may expand up to 76 inches in length.

### BRIEF DESCRIPTION OF DRAWINGS

FIG. 1 depicts a tie-down device in accordance with the present invention and expanded position.

FIG. 2 depicts the tie-down device in accordance with the prevent invention in a collapsed position.

### DETAILED DESCRIPTION

The present invention relates to a tie-down device that is used to assist in the securing of cargo onto a roof rack of a motor vehicle. Many travelers use roof racks to secure cargo for transport. Cargo such as luggage, canoes, kayaks, bicycles or other devices are typically secured onto a roof rack. The user usually uses a strap or bungee straps to secure the luggage in a secured position will secure the cargo in a secure position. The present invention relates to a tie-down device that helps the user to extend a strap over the cargo without the need of a foot ladder or stepping on the edges of the bumper of their vehicle. The present invention is a rod with a telescoping section and handle, where a hook extends from one end of the rod. A handle is provided at the opposing end to allow the user to maneuver the tie-down device over the cargo positioned on the roof rack. The hook attaches to a strap that is usually of sufficient length to place over the cargo and extent over the cargo. Usually, the strap goes under the roof rack crossbars and then back over the top of the cargo. This tie-down device enables the user to attach the hook to the strap at the center of the roof and then extend the strap over the cargo back to the outside edge of the roof rack

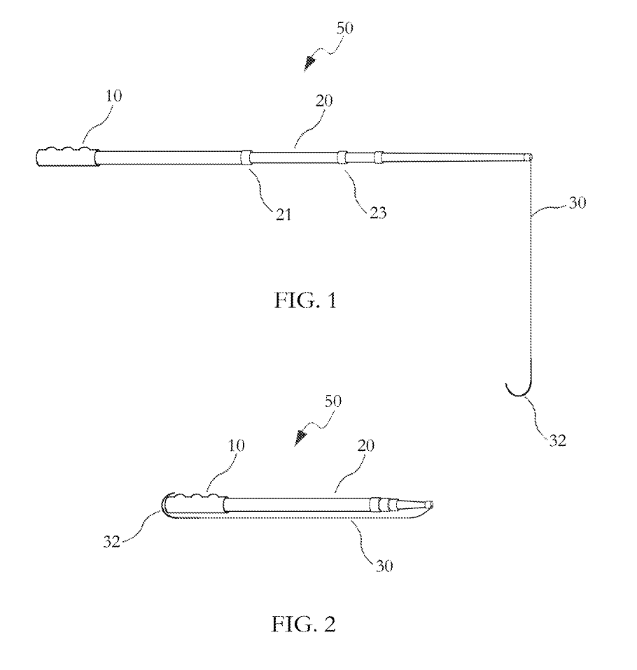

In reference to FIG. 1, a tie-down device 50 in accordance with the present invention is depicted. As shown in FIG. 1, the tie-down device 50 is in an expanded position. In this expanded position, a telescoping rod 20 is shown. The telescoping rod 20 includes sectional dividers 21 and 23 as shown. At a first end of the rod 20 is a handle 10 that is used to maneuver the telescoping rod 20 into position over the cargo on the roof rack. At the opposing end of the rod 20 is a hook 32. The hook 32 is secured to the opposite end of the rod's 20 handle end. The hook 32 also includes an extended stem 30, where the extended stem 30 provides additional length for the hook 32.

In reference to FIG. 2, the tie-down device 50 in accordance with the present invention is depicted, wherein the telescoping rod 20 is collapsed for storage purposes. In this position the hook 32 extends back to the handle 10 and abuts the end of the handle 10. Further the tie-down device 50 is expandable up to 76 inches in one particular embodiment. This expansion provides sufficient length to extend over the cargo to the mid point of the vehicle's roof. When securing cargo on the vehicle's roof rack the tie-down device goes over the cargo and the hook is attached the strap at the mid-point of the roof. The strap is then pulled over the cargo to the outside of the roof rack and then drawn tight over the cargo. Use of the tie-down device according to the present invention decreases the amount of time necessary to secure cargo and eliminates the risk of using a stepladder or climbing onto the vehicle to secure cargo with conventional straps and bungee cords. The instant invention has been shown and described in what it considers to be the most practical and preferred embodiments. It is recognized, however, that departures may be made there from within the scope of the invention and that obvious modifications will occur to a person skilled in the art.

1. A tie down device adapted for securing cargo to a vehicle roof rack comprising:
a. a telescoping rod, where the telescoping rod may vary in length;
b. a first end of the telescoping rod;
c. a second end of the telescoping rod; and
d. a hook extending from the second end of the telescoping rod.

2. The tie down device according to claim 1, where the first end includes a handle.

3. The tie down device according to claim 1, where the hook is flexible.

4. The tie down device according to claim 1, where the telescoping rod expands to various lengths.

5. The tie down device according to claim 4, where the telescoping rod expands up to 76 inches in length.

6. A method for using a telescoping rod securing cargo on a vehicle roof rack comprising the steps of:
a. extending an adjustable telescoping rod over cargo placed on a vehicle roof rack where the telescoping rod includes a first end and a second end with a hook extending from the second end;
b. attaching the hook to a strap extending under the cargo at a midpoint;
c. pulling the strap over the cargo to the outside of the roof rack; and
d. securing the cargo in place by tying down the strap on the outside of the edge of the roof rack.
